(19) United States
(12) Patent Application Publication
(10) Pub. No.: US 2026/0250860 A1
(43) Pub. Date: Aug. 27, 2026

(54) WASTE HEAT UTILIZATION-BASED BIOELECTROCHEMICAL AMMONIA RECOVERY STACK SYSTEM AND AMMONIA RECOVERY METHOD

(71) Applicant: Tianjin University, Tianjin (CN)

(72) Inventors: Siyuan ZHAI, Tianjin (CN); Xurong WANG, Tianjin (CN); Wei MA, Tianjin (CN); Yingxin ZHAO, Tianjin (CN)

(73) Assignee: Tianjin University, Tianjin (CN)

(21) Appl. No.: 19/536,764

(22) Filed: Feb. 11, 2026

(30) Foreign Application Priority Data
May 30, 2025 (CN) 202510717587.6

(51) Int. Cl. C25B 9/67; C02F 3/00; C02F 101/16; C25B 1/27; C25B 9/77; C25B 11/02; C25B 11/043; C25B 11/046; C25B 13/08

(52) U.S. Cl. CPC C25B 9/67; C02F 3/005; C25B 1/27; C25B 9/77; C25B 11/02; C25B 11/043; C25B 11/046; C25B 13/08; C02F 2101/16; C02F 2201/46115; C02F 2303/10

(57) ABSTRACT

The present disclosure provides a waste heat utilization-based bioelectrochemical ammonia recovery stack system and an ammonia recovery method. The system comprises a heat utilization unit, a power supply, and multiple cathode, anode, and recovery units. Structurally, the heat utilization unit serves as the central core, with cathode units positioned on both sides. Multiple anode and cathode units are arranged in an alternating sequence, and the recovery unit is located adjacent to the final cathode unit. Cation exchange membranes and plate-type composite ammonia stripping membranes are arranged with catholyte inlets and outlets of multiple cathode units to provide for anolyte inlets of multiple anode units to be connected on the same side either in parallel or in series with the anolyte outlet. The system facilitates in-situ utilization of waste heat from introduced high-temperature wastewater, thereby achieving efficient treatment of high-temperature ammonia-nitrogen wastewater and highly efficient recovery of nitrogen resources.

### TECHNICAL FIELD

The present disclosure pertains to the field of sewage treatment and resource recovery technology, particularly to a waste heat utilization-based bioelectrochemical ammonia recovery stack system and an ammonia recovery method.

### BACKGROUND

Industrial fields such as petroleum exploitation, chemical industry, textile printing and dyeing, food processing, and biopharmaceuticals frequently generate high-temperature wastewater containing substantial waste heat. The thermal energy inherent in this wastewater possesses significant potential for recovery and constitutes a form of low-grade thermal energy. Nevertheless, such high-temperature wastewater cannot be directly introduced into the biochemical units of wastewater treatment plants (WWTP) necessitating a pretreatment step for temperature reduction. The prevailing approach follows a “cooling+stepwise treatment” mode, such as constructing an equalization basin at the WWTP to cool the raw water, which is subsequently directed to biochemical treatment units once its temperature reaches a suitable range. Although this approach achieves the discharge standards, it requires additional construction investment compared to treating ambient-temperature wastewater and suffers from reduced treatment efficiency. Consequently, the reuse of this low-grade thermal energy from wastewater presents considerable application potential compared to its removal.

Existing technologies for reusing low-grade thermal energy, such as heat pumps and thermoelectric coupling methods, suffer from limitations including complex equipment, low utilization rates, insufficient operational stability, and poor economic viability. Moreover, most high-temperature wastewater not only contains untapped low-grade thermal energy but also contains other resources with reuse value. For instance, coking wastewater in China is characterized by high temperature (60-80° C.) and high ammonia nitrogen content (200-700 mg/L). Beyond the challenging-to-recover heat, the high concentration of ammonia nitrogen also complicates effective biochemical treatment, leading to a failure to meet discharge standards and environmental issues such as water eutrophication. Since ammonia nitrogen is an important chemical feedstock, the nitrogen resource in wastewater holds significant recovery value. Currently, industrially competitive nitrogen recovery methods primarily include stripping, thermal stripping, ion exchange, and chemical precipitation. Nevertheless, these conventional physico-chemical methods are still limited by high energy consumption, low recovery rates, and high investment and operational costs, which greatly reduces their practical application attraction.

In recent years, the Bioelectrochemical System (BES) has found widespread application in recovering ammonia nitrogen resources from wastewater. Among existing configurations, the dual-chamber BES-ammonia recovery is particularly representative. This system primarily includes an anode unit, a cathode unit, a cation exchange membrane (CEM), electrode materials, an external circuit, and an ammonia recovery unit. In this system, wastewater containing organic matter flows through the anode unit, where electroactive microorganisms oxidize organic matter to generate electrons. Then, electron transfer facilitates NH₄⁺ migration through the CEM to the cathode unit, achieving both charge balance and NH₄⁺ separation. Nevertheless, when treating actual wastewater with complex compositions, BES systems typically face challenges such as poor stability and low treatment efficiency. Consequently, coupling BES with other synergistic methods is necessary to enhance its treatment efficiency and long-term operational stability. If the low-grade thermal energy from high-temperature wastewater can be utilized to enhance the treatment efficiency of the BES system, it would further improve the operational performance of the BES system in actual wastewater applications, enabling not only the reuse of high-temperature wastewater but also improving nitrogen resource recovery efficiency. By transforming difficult-to-treat low-grade thermal energy into a synergistic measure, this approach not only reduces treatment costs but also improves treatment effectiveness, making it exceptionally valuable for practical application.

### SUMMARY

In view of the foregoing, in order to address the aforementioned technical problems, the present disclosure provides a waste heat utilization-based bioelectrochemical ammonia recovery stack system and a method for recovering ammonia nitrogen from wastewater based on this system. The system employs a stack configuration to in-situ utilize the waste heat from the introduced high-temperature wastewater, enabling efficient treatment of high-temperature ammonia nitrogen wastewater and highly efficient recovery of nitrogen resources at low cost.

In order to achieve the above objective, the technical solution of the present disclosure is achieved as follows:
in a first aspect, the present disclosure provides a waste heat utilization-based bioelectrochemical ammonia recovery stack system, including a heat utilization unit, a cathode unit, an anode unit, a recovery unit, and a power supply;
the heat utilization unit is provided with a wastewater inlet and a wastewater outlet; the cathode unit is provided with a catholyte inlet and a catholyte outlet, and a cathode is arranged in the cathode unit; the anode unit is provided with an anolyte inlet and an anolyte outlet, and an anode is arranged in the anode unit; the recovery unit is provided with an absorbent solution outlet; a negative terminal of the power supply is connected to the cathode, and a positive terminal of the power supply is connected to the anode;
the cathode units are arranged on both sides of the heat utilization unit, and the anode units are arranged on an opposite side of each cathode unit; there are multiple cathode units and multiple anode units, the multiple cathode units and the multiple anode units are arranged on both sides of the heat utilization unit in an alternating sequence, with the cathode unit positioned at each outermost end, the recovery unit is arranged on a side opposite to the two last cathode units; the heat utilization unit and the cathode unit, as well as the cathode unit and the anode unit, are each separated by a cation exchange membrane; the cathode units are separated from the recovery units by plate-type composite ammonia separation membranes;
the multiple cathode units on a same side of the heat utilization unit are connected in series through the catholyte outlet of a preceding cathode unit and the catholyte inlet of a succeeding cathode unit; the anolyte inlets of multiple anode units on a same side of the heat utilization unit are connected in parallel to the wastewater outlet, or multiple anode units on the same side of the heat utilization unit are connected in series through the anolyte outlet of a preceding anode unit and the anolyte inlet of a succeeding anode unit, in which the anolyte inlet of the anode unit closest to the heat utilization unit is connected to the wastewater outlet.

Through the rational configuration of the heat utilization unit, cathode unit, anode unit, and recovery unit, the system achieves in-situ heat utilization and a recovery of high-purity ammonium salts. High-temperature wastewater can be fed directly into the device without pre-cooling, maximizing heat utilization and preventing thermal losses. The system distributes the thermal energy at different temperature gradients to specific reaction units to perform functions: 1) in the heat utilization unit, the high-temperature wastewater increases the ammonia separation rate and the ammonia conversion rate of the cathode by shifting the NH₄⁺/NH₃ equilibrium to the right; 2) after being cooled to a certain degree, the wastewater flows into the anode unit, where the thermal energy enhances microbial reaction activity and a diffusion mass transfer rate of NH₄, thereby increasing an ammonia transfer rate and a recovery rate. This gradient utilization of thermal energy improves ammonia nitrogen resource recovery while minimizing energy waste to the greatest extent.

The anode unit, cathode unit, heat utilization unit, and recovery unit of the system feature a high degree of modular similarity, enabling flexible and dynamic stack configurations. The integration of the recovery unit into the stack is achieved by employing the plate-type composite ammonia separation membrane between the recovery unit and the cathode unit. This design forms an integrated reaction device, eliminating the issues associated with conventional standalone recovery devices, such as increased construction costs and system complexity. Positioned adjacent to the cathode unit, the heat utilization unit leverages a positive temperature differential to enhance the ammonia conversion rate and its transmembrane transfer rate to the cathode through the cation exchange membrane. The number of stacks of the heat utilization unit can be scaled up or down based on regional or temporal water quality variations, as long as it is ensured that the cathode unit is arranged on both sides of the heat utilization unit. Similar to the heat utilization unit, the number of recovery units can be adjusted according to required purity and specific treatment processes, with the constraint that only the recovery units are disposed at the ends of the cathode units for effluent recovery. The system offers high operational flexibility, as different functional units can be interchanged by adjusting the inlet pipes and pipe connections of each chamber, enabling the recovery of nitrogen resources within targeted concentration and rate ranges.

To accommodate different actual working conditions, the system can employ various stack connection modes, enabling a diversified stack. If the wastewater has a relatively low ammonia nitrogen load but a large influent flow, a parallel mode can be adopted. In this mode, the anolyte inlets of multiple anode units on the same side of the heat utilization unit are connected in parallel to the wastewater outlet. In this parallel configuration, the effluent from the heat utilization unit is distributed in parallel to each anode unit. The addition of each anode unit effectively doubles the system's flow capacity, thereby greatly enhancing treatment efficiency. Conversely, if stringent discharge standards of wastewater apply, a series connection mode can be adopted, in this mode, multiple anode units on the same side of the heat utilization unit are connected in series, with the anolyte outlet of each preceding anode unit connected to the anolyte inlet of the succeeding anode unit, and the anolyte inlet of the anode unit closest to the heat utilization unit connected to the wastewater outlet. In series mode, the effluent from the first anode unit serves as the influent for the second anode unit, and the effluent of the heat utilization unit flows into each anode unit in turn from the first anode unit. This arrangement allows for gradient treatment of high-concentration ammonia nitrogen, with the concentration progressively reduced until discharge standards are met. This serial gradient removal achieves a stepwise decrease in ammonia nitrogen concentration and significantly improves removal rates. In addition to the anode unit, whether it is connected in series or parallel, the cathode units are all connected in series. Series-connected cathode units enable the concentration and enrichment of ammonia nitrogen. When this concentrated ammonia nitrogen enters the recovery unit, the concentration difference between the high-concentration ammonia nitrogen and the absorbent solution within the recovery unit further enhances the recovery rate of the recovery unit.

In some preferred embodiments of the waste heat utilization-based bioelectrochemical ammonia recovery stack system of the present disclosure, the anode is a carbon-based material or a metal-based material; the cathode is a carbon-based material or a metal-based material.

In some preferred embodiments of the waste heat utilization-based bioelectrochemical ammonia recovery stack system of the present disclosure, the anode is a carbon brush, carbon felt, or carbon cloth; the cathode is a carbon brush, carbon felt, carbon cloth, stainless steel 316L, or stainless steel 304.

In some preferred embodiments of the waste heat utilization-based bioelectrochemical ammonia recovery stack system of the present disclosure, the temperature of ammonia nitrogen wastewater charged into the heat utilization unit is 40-100° C.; the catholyte charged into the cathode unit is NaCl solution; the absorbent solution charged into the recovery unit is dilute sulfuric acid, dilute hydrochloric acid or dilute nitric acid.

In some preferred embodiments of the waste heat utilization-based bioelectrochemical ammonia recovery stack system of the present disclosure, a concentration of the catholyte is 40-60 mmol/L.

In some preferred embodiments of the waste heat utilization-based bioelectrochemical ammonia recovery stack system of the present disclosure, the plate-type composite ammonia separation membrane includes a main membrane located in an intermediate layer and a supporting membrane arranged on both sides of the main membrane; a material of the main membrane is polytetrafluoroethylene (PTFE), a thickness of the main membrane is 0.32-0.36 mm, with a pore size of 0.1 μm; a material of the supporting membrane is polypropylene (PP).

In some preferred embodiments of the waste heat utilization-based bioelectrochemical ammonia recovery stack system of the present disclosure, the plate-type composite ammonia separation membrane further includes supporting meshes arranged on both sides of the supporting membrane, a material of the supporting mesh is a plastic network of heat-resistant materials, such as polyethylene (PE).

The plate-type composite ammonia separation membrane is a gas-selective plate membrane characterized by its gas-liquid separation capability. It functions to block liquid while allowing the passage of free ammonia when in contact with a liquid containing free ammonia. At its core, the membrane comprises hydrophobic and gas-permeable materials, with PTFE being the selected material. Key parameters, including pore size, thickness, acid and alkali tolerance threshold, and temperature tolerance threshold, are rationally selected according to application requirements. Among these, the membrane pore size is the parameter most directly correlated with the membrane's waterproofness and gas permeability. Common average pore sizes for waterproof and gas-permeable membranes include 1 μm, 0.45 μm, 0.22 μm, and 0.1 μm. Generally, a smaller pore size confers greater waterproofness but results in reduced gas permeability and higher cost. Therefore, it is necessary to choose reasonably according to the actual working conditions. PTFE membrane is employed as the main membrane material not only for its excellent acid and alkali resistance but also for its certain mechanical strength.

The plate-type composite ammonia separation membrane in this system is employed in two structural configurations. The first configuration employs a ‘supporting membrane (PP)+main membrane (PTFE)+supporting membrane (PP)’ structure. In this design, the PP material, which serves a merely supportive role (being permeable to water and gas), and the waterproof and gas-permeable PTFE functional membrane are tightly bonded together via a lamination process, sandwiching the functional membrane between the support materials. This method significantly extends the service life of the PTFE membrane, and its simple composite design minimizes the impact on gas mass transfer. However, it is susceptible to damage under high water pressure and substantial hydraulic shear forces, making it more suitable for applications with relatively small treatment scales and device volumes. While this multilayer composite enhances the membrane's mechanical strength, the associated cost increase is relatively small. The second configuration employs a ‘supporting mesh (PE)+supporting membrane (PP)+main membrane (PTFE)+supporting membrane (PP)+supporting mesh (PE)’ structure. This design greatly improves the impact resistance of the plate-type composite ammonia separation membrane. The supporting mesh stabilizes the adhesion between the main membrane and the supporting membranes and provides a certain hardness and mechanical strength to the plate-type composite ammonia separation membrane. This enables long-term, stable recovery performance in large-scale processing systems and complex actual operating conditions. A practical consideration is the corrosion and wear of the external supporting mesh over time, which adds to operating costs. Therefore, in practical applications, different membrane assemblies can be selected and combined based on the specific reaction device scale and operating conditions, aiming to balance treatment effectiveness with capital investment.

In a second aspect, the present disclosure provides an ammonia recovery method for a waste heat utilization-based bioelectrochemical ammonia recovery stack system, including the following steps:
S1, microbial activation:
S1.1, applying an external voltage to the anode unit and the cathode unit to initiate;
S1.2, introducing a mixture of the ammonia nitrogen wastewater and a microbial inoculum at room temperature into the anode unit, introducing a catholyte into the cathode unit, performing an influent flow continuously for acclimation, and maintaining a culture temperature at ambient temperature; and
S1.3, after the current is stable, achieving a successful activation; and
S2, ammonia nitrogen wastewater treatment:
introducing high-temperature ammonia nitrogen wastewater with a temperature of 40-100° C. into the heat utilization unit from the wastewater inlet; after the high-temperature ammonia nitrogen wastewater exchanges heat with an adjacent cathode unit, flowing into the anode units connected in parallel from the wastewater outlet, followed by discharging treated wastewater from the anolyte outlet; alternatively, sequentially passing through the anode units connected in series, treating the high-concentration ammonia nitrogen in a gradient manner to gradually reduce the ammonia nitrogen concentration, and finally discharging the treated wastewater from the anolyte outlet of a last anode unit; introducing the catholyte into the cathode unit through the catholyte inlet; generating electrons from organic matter at the anode, driving NH₄⁺ from the anode unit to enter the cathode unit through the cation exchange membrane by the resulting current, and converting the NH₄⁺ into free ammonia under alkaline conditions, achieving the concentration and enrichment of ammonia nitrogen through the catholyte containing free ammonia passes through multiple cathode units in series, after entering the last cathode unit, allowing the free ammonia to diffuse into the absorbent solution in the recovery unit through the plate-type composite ammonia separation membrane, and discharging a saturated absorbent solution from the absorbent solution outlet.

In some preferred embodiments of the ammonia recovery method of the present disclosure, in S1.1, an external voltage of 0.8 V is applied;
in S1.2, a volume of ammonia nitrogen wastewater and microbial inoculum in the mixture is 1:1; a hydraulic retention time (HRT) of the mixture in the anode unit is 8-16 h;
in S2, a HRT of ammonia nitrogen wastewater in the anode unit is 5-16 h.

Compared with the existing technology, the waste heat utilization-based bioelectrochemical ammonia recovery stack system and the ammonia recovery method described in the present disclosure have the following advantages:
(1) In the present disclosure, the waste heat utilization-based bioelectrochemical ammonia recovery stack system employs a rationally configuration, which enables the in-situ utilization of thermal energy and the recovery of high-purity ammonium salts. Without requiring additional cooling, the high-temperature wastewater directly enters the heat utilization unit and exchanges heat with the adjacent cathode unit, which increases the ammonia separation rate and the ammonia conversion rate of the cathode by shifting the NH₄⁺/NH₃ equilibrium to the right. Following heat exchange, after being cooled to a certain degree, the wastewater flows into the anode unit, where the residual thermal energy enhances microbial reaction activity and a diffusion mass transfer rate of NH₄⁺, thereby increasing the ammonia transfer rate and the recovery rate. In this manner, the heat inherent in the wastewater is distributed to different reaction units to perform distinct functions. This gradient utilization of thermal energy avoids the loss of thermal energy, reduces treatment costs, enhances the recovery of ammonia-nitrogen resources, and minimizes energy waste to the greatest extent.
(2) In the present disclosure, the waste heat utilization-based bioelectrochemical ammonia recovery stack system achieves in-situ utilization of thermal energy and in-situ treatment of high ammonia nitrogen wastewater, thereby significantly reducing the costs associated with energy loss, energy transportation, and pipeline losses. Simultaneously, the full utilization of high-temperature wastewater across the entire temperature range (40° C.-100° C.) is achieved, which maximizes the use of low-grade thermal energy contained in the wastewater, and addresses the issue of low thermal energy utilization efficiency.
(3) In the present disclosure, the waste heat utilization-based bioelectrochemical ammonia recovery stack system features a rational structural design. While the prior BES-ammonia recovery systems predominantly rely on independent recovery units for nitrogen resource utilization, the present disclosure integrates a recovery unit equipped with a plate-type composite ammonia separation membrane directly into the BES reaction body. By configuring this recovery unit as a chamber of the reactor, an integrated reaction device is formed. This configuration optimizes the ammonia migration pathway, reduces ammonia loss, and significantly reduces additional construction costs due to the structural complexity of the reaction apparatus.
(4) In the present disclosure, the waste heat utilization-based bioelectrochemical ammonia recovery stack system can be flexibly assembled according to actual working conditions, allowing for the functional replacement of each chamber without constructing additional reaction units. The heat utilization unit, which operates based on the low-grade thermal energy from the raw wastewater, does not require electrode intervention, thereby reducing capital construction costs to a certain extent. The present disclosure employs a dynamic stack system to couple nitrogen separation, concentration, and purification processes, while in-situ utilizing the low-grade thermal energy carried by the wastewater to enhance the efficiency of nitrogen resource recovery. Meanwhile, the infrastructure costs and operation and maintenance costs are lower compared to those of conventional treatment processes.
(5) In the present disclosure, through the in-situ gradient utilization of temperature, the thermal energy within different ranges is distributed among different reaction units. This enhances the electrochemical performance and the reaction kinetics of ammonia nitrogen removal, thereby improving the ammonia nitrogen removal efficiency. Under the same HRT, within a series-stack configuration, the system achieves an ammonia removal efficiency of 91.73% by utilizing the system with direct high-temperature wastewater influent for thermal energy enhancement. Compared to the 61.25% ammonia removal efficiency obtained with ambient-temperature influent, the ammonia removal rate is increased by 30.48%. It demonstrates that the system can directly treat high-temperature wastewater (40-100° C.) and achieve better ammonia nitrogen removal. In a true sense, it accomplishes the objective of “converting low-grade thermal energy into a synergistic means, which not only allows for the reuse of high-temperature wastewater but also improves the recovery efficiency of nitrogen resources”.
(6) The dynamic stack system constructed in the present disclosure can enhance the the ammonia nitrogen removal and recovery performance through the stack configuration. Concurrently, the catholyte undergoes multiple stages of concentration and purification, ultimately yielding a high-purity ammonia concentrate recovered by the recovery unit. Under identical conditions of ambient temperature and HRT, the system achieves an ammonia nitrogen removal rate of 61.25% (room temperature), which is 20.70% higher than the 40.55% removal rate of a conventional BES device. Furthermore, when compared to the 91.73% ammonia nitrogen removal rate obtained under high-temperature wastewater influent conditions, the ammonia nitrogen removal rate of the system is increased by 51.18%. This demonstrates that, even when treating ambient-temperature wastewater, the system offers a great improvement in ammonia nitrogen treatment efficiency over conventional BES devices, attributable to its rational structural design.
(7) The present disclosure employs a plate-type composite ammonia separation membrane. Compared to other recovery methods, this method does not require additional energy utilization. Furthermore, the plate-and-frame membrane module provides a larger contact area. The cathode unit and the recovery unit are of identical volume and structure, which is more conducive to transmission, establishes a more stable mass transfer equilibrium, and thereby improves the recovery rate. In comparison, the energy-consuming aeration stripping process typically yields a recovery rate ranging from 68% to 82%, the series-stack configuration, which exhibits the highest removal efficiency, can achieve an ammonia removal rate of 91.73%.

### BRIEF DESCRIPTION OF THE DRAWINGS

The drawings constituting part of the present disclosure are provided to facilitate further understanding of the present disclosure. The illustrative embodiments of the present disclosure and descriptions thereof are intended to explain the present disclosure and do not constitute undue limitations on the scope of the present disclosure. In the drawings:

FIG. 1 is a schematic structure diagram of a waste heat utilization-based bioelectrochemical ammonia recovery stack system according to Embodiment 1 of the present disclosure;

FIG. 2 is a schematic structural diagram of a waste heat utilization-based bioelectrochemical ammonia recovery stack system according to Embodiment 2 of the present disclosure;

FIG. 3 is a schematic structural diagram of a waste heat utilization-based bioelectrochemical ammonia recovery stack system according to Embodiment 3 of the present disclosure;

FIG. 4 is a schematic structural diagram of a plate-type composite ammonia separation membrane according to the present disclosure.

### REFERENCE NUMERALS IN FIGURES

1—a heat utilization unit; 2—a cathode unit; 3—an anode unit; 4—a recovery unit; 5—a power supply; 6—a wastewater inlet; 7—a wastewater outlet; 8—a catholyte inlet; 9—a catholyte outlet; 10—a cathode; 11—an anolyte inlet; 12—an anolyte outlet; 13—an anode; 14—an absorbent solution outlet; 15—a cation exchange membrane; 16—a plate-type composite ammonia separation membrane; 17—a main membrane; 18—a supporting membrane; 19—a supporting mesh.

### DETAILED DESCRIPTION OF THE EMBODIMENTS

It should be noted that, whenever there is no inconsistency, the embodiments of the present disclosure and the features within the embodiments may be combined with one another.

In the description of the present disclosure, it should be further noted that, unless otherwise explicitly specified and defined, the terms “arrangement”, “connecting” and “connection” should be understood in a broad sense, for example, they may be a fixed connection, a detachable connection, or an integrated connection; may be a mechanical connection, or an electrical connection; and may be a direct connection, or an indirect connection via an intermediate medium, or communication inside two elements. For those of ordinary skill in the art, the specific meanings of the above terms in the present disclosure may be understood according to specific circumstances.

The following will describe the present disclosure in detail with reference to the accompanying drawings and in conjunction with the embodiments.

### Embodiment 1

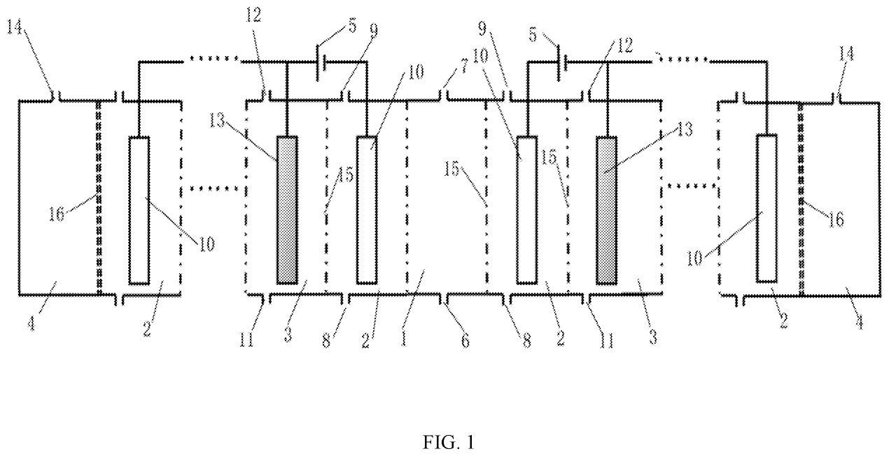

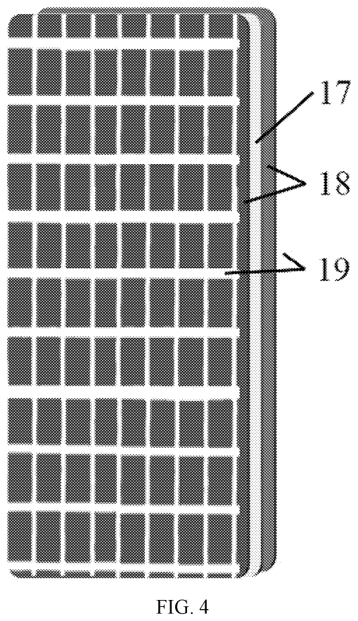

As shown in FIG. 1, the present disclosure provides the waste heat utilization-based bioelectrochemical ammonia recovery stack system, including the heat utilization unit 1, the cathode unit 2, the anode unit 3, the recovery unit 4, and the power supply 5;
the heat utilization unit 1 is provided with the wastewater inlet 6 and the wastewater outlet 7; the cathode unit 2 is provided with the catholyte inlet 8 and the catholyte outlet 9, and the cathode 10 is arranged in the cathode unit 2; the anode unit 3 is provided with the anolyte inlet 11 and the anolyte outlet 12, and the anode 3 is arranged in the anode unit 13; the recovery unit 4 is provided with the absorbent solution outlet 14; the negative terminal of the power supply 5 is connected to the cathode 10, and the positive terminal of the power supply 5 is connected to the anode 13;
the cathode units 2 are arranged on both sides of the heat utilization unit 1, and the anode units 3 are arranged on the opposite side of each cathode unit 2; there are multiple cathode units 2 and multiple anode units 3, the multiple cathode units 2 and the multiple anode units 3 are arranged on both sides of the heat utilization unit 1 in an alternating sequence, with the cathode unit 2 positioned at each outermost end, the recovery unit 4 is arranged on the side opposite to the two last cathode units 2; the heat utilization unit 1 and the cathode unit 2, as well as the cathode unit 2 and the anode unit 3, are each separated by the cation exchange membrane 15; the cathode units 2 are separated from the recovery units 4 by the plate-type composite ammonia separation membranes 16;
the multiple cathode units 2 on the same side of the heat utilization unit 1 are connected in series through the catholyte outlet 9 of the preceding cathode unit 2 and the catholyte inlet 8 of the succeeding cathode unit 2; the anolyte inlets 11 of multiple anode units 3 on the same side of the heat utilization unit 1 are connected in parallel to the wastewater outlet 7, or multiple anode units 3 on the same side of the heat utilization unit 1 are connected in series through the anolyte outlet 12 of the preceding anode unit 3 and the anolyte inlet 11 of the succeeding anode unit 3, in which the anolyte inlet 11 of the anode unit 3 closest to the heat utilization unit 1 is connected to the wastewater outlet 7.

Wherein the cation exchange membrane 15 is a cation exchange membrane CMI-7000. Four self-made carbon brushes (8 cm in height, 3 cm in diameter) are used for both anode 13 and cathode 10; the catholyte is a 50 mmol/L sodium chloride solution; both the recovery unit 4 and the heat utilization unit 1 had a volume of 200 mL; the absorbent solution in the recovery unit 4 is 1 L of 0.1 mol/L dilute sulfuric acid solution. As shown in FIG. 4, the plate-type composite ammonia separation membrane 16 includes the main membrane 17 located in the intermediate layer, the supporting membrane 18 arranged on both sides of the main membrane 17, and the supporting meshes 19 arranged on both sides of the supporting membrane 18. The material of the main membrane 17 is PTFE, the material of the supporting membrane 18 is PP, and the material of the supporting mesh 19 is PE.

The preparation process of the carbon brush is as follows:

Carbon fiber (TZ300 3K, supplied by Weihai Guangwei Composite Materials Co., Ltd.) is bundled to two intertwined titanium wires (supplied by Tianjin Hongfeng Weili Technology Development Co., Ltd.). Then it is washed with deionized water to remove surface impurities, soaked in an acetone solution for 24 h, and calcined in a muffle furnace at 600° C. for 0.5 h. Subsequently, it is washed with a 1 mol/L dilute hydrochloric acid solution to remove surface oxidation products, and finally rinsed with deionized water and dried in an oven to yield the carbon brush.

The preparation method of the plate-type composite ammonia separation membrane is as follows:

The ‘supporting mesh (PE)+supporting membrane (PP)+main membrane (PTFE)+supporting membrane (PP)+supporting mesh (PE)’ structure is employed: three membranes of supporting membrane+main membrane+supporting membrane are pressed into the membrane main body, the thickness of the main membrane is approximately 0.32-0.36 mm, which is comparable to two sheets of A4 paper, with a pore size of 0.1 μm, the membrane pore diameter can withstand a pressure of 4 kg, and the membrane area is 0.022 m². The assembly is externally supported and fixed by supporting meshes, with the two supporting meshes connected by titanium wires.

### Embodiment 2

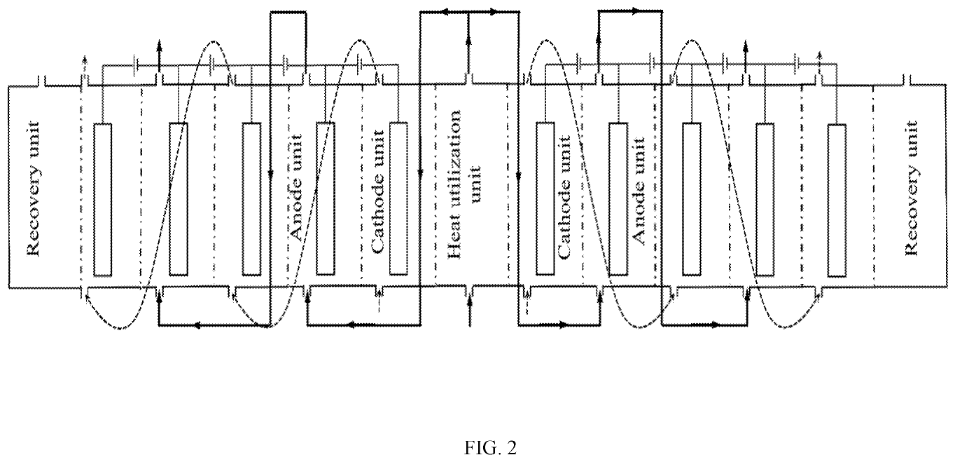

On the basis of Embodiment 1, as shown in FIG. 2, the series connection mode of ‘multiple anode units 3 on the same side of the heat utilization unit 1 are connected in series through the anolyte outlet 12 of the preceding anode unit 3 and the anolyte inlet 11 of the succeeding anode unit 3, in which the anolyte inlet 11 of the anode unit 3 closest to the heat utilization unit 1 is connected to the wastewater outlet 7’ is employed. The system is configured in a series-stack arrangement with two sets including the anode unit 3 and the cathode unit 2 arranged on both sides, respectively (both sides are also provided with the recovery unit 4 and the cathode unit 2 connected to recovery unit 4, respectively).

The ammonia recovery method for the waste heat utilization-based bioelectrochemical ammonia recovery stack system under this series structure is as follows:
S1, microbial activation:
S1.1, the external voltage of 0.8 V is applied to the anode unit 3 and the cathode unit 2 to initiate;
S1.2, the mixture of actual ammonia nitrogen wastewater from a factory (at a room temperature of 23.62° C.) and microbial inoculum (in a 1:1 volume ratio) is introduced into anode unit 3. A 50 mmol/L sodium chloride solution is introduced into cathode unit 2. Continuous influent flow is performed for acclimation at an influent flow rate of 10 mL/h, with a HRT of 12 h, and the cultivation temperature is maintained at the ambient temperature.
S1.3, after the current is stable, the successful activation is achieved; and
S2, ammonia nitrogen wastewater treatment:

High-temperature wastewater (water quality parameters: chemical oxygen demand (COD) 500±13 mg/L, NH₄⁺—N 100±6.3 mg/L; water temperature: 83.64° C.) is introduced into the heat utilization unit 1 from the wastewater inlet 6 under temperature-monitored conditions. After the high-temperature ammonia nitrogen wastewater is heat exchanged with the adjacent cathode unit 2, it flows from the wastewater outlet 7 and flows sequentially through the series-connected anode units 3 (HRT in the anode unit is 8 h; anode influent flow rate is 22.5 mL/h). Within this series, the high-concentration ammonia nitrogen is treated in a gradient manner to gradually reduce the ammonia nitrogen concentration, and finally, the treated wastewater is discharged from the anolyte outlet 12 of the last anode unit 3. Concurrently, the catholyte is introduced into the cathode unit 2 through the catholyte inlet 8; electrons are generated from organic matter at the anode, whose directional movement produced the current, and the NH₄⁺ are driven from the anode unit 3 to enter the cathode unit 2 through the cation exchange membrane 15 by the resulting current, where they are converted into free ammonia under highly alkaline conditions. The concentration and enrichment of ammonia nitrogen is achieved through the catholyte containing free ammonia passes through multiple cathode units 2 in series, after entering the last cathode unit 2, the free ammonia is allowed to diffuse into the absorbent solution in the recovery unit 4 through the plate-type composite ammonia separation membrane 16, where it is converted into an (NH₄)₂SO₄ salt solution. The saturated absorbent solution is subsequently discharged from the absorbent solution outlet 14.

When the current potential is stabilized for 7 d, the ammonia nitrogen concentration in the final anode effluent in the stable stage is 10.49 mg/L, and the removal rate is 91.73% (the ammonia nitrogen removal rate is a ratio of the difference between ammonia nitrogen in the anode influent and effluent to the amount of ammonia nitrogen in the anode influent), the N content in the ammonia recovery unit is measured, and the proportion of N recovered into the acid absorbent solution in the removed N is 0.89.

### Embodiment 3

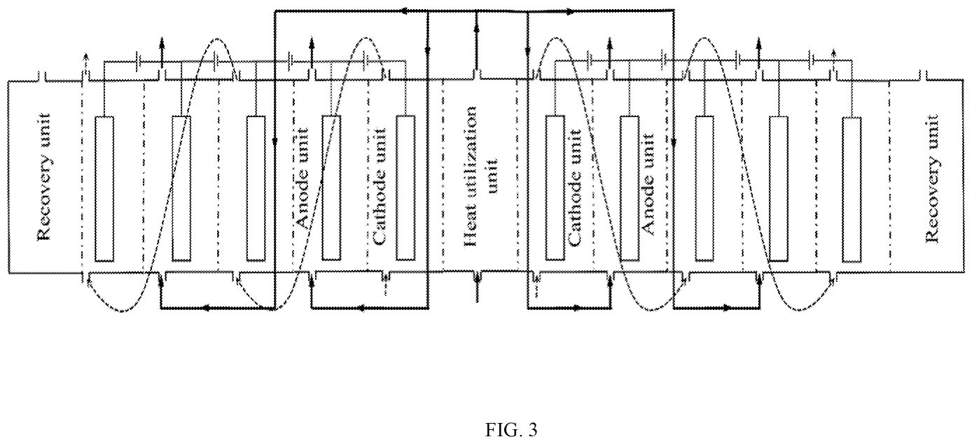

On the basis of Embodiment 1, as shown in FIG. 3, the parallel connection mode of ‘the anolyte inlets 11 of multiple anode units 3 on the same side of the heat utilization unit 1 are connected in parallel to the wastewater outlet 7’ is employed. The system is configured with two sets including the anode unit 3 and the cathode unit 2 arranged on both sides, respectively (both sides are also provided with the recovery unit 4 and the cathode unit 2 connected to recovery unit 4, respectively).

The ammonia recovery method for a waste heat utilization-based bioelectrochemical ammonia recovery stack system under this parallel structure is as follows:
S1, microbial activation:
S1.1, the external voltage of 0.8 V is applied to the anode unit 3 and the cathode unit 2 to initiate;
S1.2, the mixture of actual ammonia nitrogen wastewater from a factory (at a room temperature of 23.62° C.) and microbial inoculum (in a 1:1 volume ratio) is introduced into the anode unit 3. A 50 mmol/L sodium chloride solution is introduced into cathode unit 2. Continuous influent flow is performed for acclimation at an influent flow rate of 10 mL/h, with a HRT of 12 h, and the cultivation temperature is maintained at ambient temperature.
S1.3, after the current is stable, the successful activation is achieved; and
S2, ammonia nitrogen wastewater treatment:

High-temperature wastewater (water quality parameters: COD 500±13 mg/L, NH₄⁺—N 100±6.3 mg/L; water temperature: 83.64° C.) is introduced into the heat utilization unit 1 from the wastewater inlet 6 under temperature-monitored conditions. After the high-temperature ammonia nitrogen wastewater is heat exchanged with the adjacent cathode unit 2, it flows from the wastewater outlet 7 and enters the parallel anode units 3 simultaneously. This configuration doubles the flow rate compared to that in Embodiment 2. Subsequently, the treated wastewater is discharged from the anolyte outlets 12. Concurrently, the catholyte is introduced into the cathode unit 2 through the catholyte inlet 8; electrons are generated from organic matter at the anode, whose directional movement produced the current, and the NH₄⁺ are driven from the anode unit 3 to enter the cathode unit 2 through the cation exchange membrane 15 by the resulting current, where they are converted into free ammonia under high alkaline conditions at the cathode. The concentration and enrichment of ammonia nitrogen is achieved through the catholyte containing free ammonia passes through multiple cathode units 2 in series, after entering the last cathode unit 2, the free ammonia is allowed to diffuse into the absorbent solution in the recovery unit 4 through the plate-type composite ammonia separation membrane 16, where it is converted into an (NH₄)₂SO₄ salt solution. The saturated absorbent solution is subsequently discharged from the absorbent solution outlet 14.

When the current potential is stabilized for 7 d, the ammonia nitrogen concentration in the final anode effluent in the stable stage is 19.49 mg/L, and the removal rate is 79.11% (the ammonia nitrogen removal rate is a ratio of the difference between ammonia nitrogen in the anode influent and effluent to the amount of ammonia nitrogen in the anode influent), the N content in the ammonia recovery unit is measured, and the proportion of N recovered into the acid absorbent solution in the removed N is 0.81.

### Comparative Embodiment 1

Ammonia nitrogen recovery is performed according to the system and method described in Embodiment 2. The difference is only that the high-temperature wastewater of the influent is reduced to room temperature. After stable operation, the ammonia nitrogen concentration in the anolyte effluent is 37.04 mg/L, and the removal rate is 61.25%. The N content in the ammonia recovery unit is measured, and the proportion of N recovered into the acid-absorbent solution in the removed N is 0.67.

### Comparative Embodiment 2

Ammonia nitrogen recovery is performed according to the system and method described in Embodiment 2. The difference is only that the high-temperature wastewater of the influent is reduced to room temperature, the conventional BES device is employed, and the stack configuration is cancelled. After stable operation, the ammonia nitrogen concentration in the anolyte effluent is 61.74 mg/L, and the removal rate is 40.55%. The N content in the ammonia recovery unit is measured, and the proportion of N recovered into the acid-absorbent solution in the removed N is 0.63.

The comparison of ammonia nitrogen removal rate and the proportion of recovered N in Embodiment 2, Embodiment 3, Comparative embodiment 1, and Comparative embodiment 2 is shown in Table 1.

| | | | Comparative | Comparative |
|---|---|---|---|---|
| | | | embodiment | embodiment |
| | Embodiment 2 | Embodiment3 | 1 | 2 |
| Removal rate(%) | 91.73 | 79.11 | 61.25 | 40.55 |
| Proportion of | 0.89 | 0.81 | 0.67 | 0.63 |
| recovered N | | | | |

The circuit current for Embodiment 2, Embodiment 3, Comparative embodiment 1, and Comparative embodiment 2 is monitored in real time using a data recorder, and the average current data are presented in Table 2.

| | | Average current in | Average current |
|---|---|---|---|
| Average current in | Average current in | Comparative | inComparative |
| Embodiment 2 | Embodiment 3 | embodiment 1 | embodiment 2 |
| (mA) | (mA) | (mA) | (mA) |
| 6.28 | 8.61 | 3.78 | 2.95 |

Combining the data of the above examples and comparative examples, it can be seen that the ammonia nitrogen removal rate and the proportion of recovered N are the highest in Embodiment 2 by adopting the mode of high-temperature influent and anode influent in series, followed by the mode of high-temperature influent and anode influent in parallel in Embodiment 3. This comparison indicates that the parallel mode of Embodiment 3 is suitable for operating conditions characterized by a relatively low ammonia nitrogen load and a high influent flow rate, whereas the series mode of Embodiment 2 is suitable for conditions requiring strict wastewater discharge standards. The data from both embodiments 2 and 3 significantly outperform those of Comparative embodiments 1 and 2, demonstrating that the stacked structure of this system enables the efficient treatment of high-temperature wastewater and efficient recovery of nitrogen resources. Furthermore, the fact that Comparative embodiment 1 yields better results than Comparative embodiment 2 further confirms that, due to its reasonable structural design, this system greatly enhances ammonia nitrogen treatment efficiency compared to conventional BES devices, even when handling ambient-temperature wastewater.

Moreover, the average current in Embodiments 2 and 3 is significantly higher than that in Comparative Embodiments 1 and 2. This demonstrates that the thermal energy from the high-temperature wastewater is fully utilized. The effective utilization of this thermal energy enhances the system's power generation efficiency, specifically, it promotes anodic electrochemical reactions, thereby driving the migration and transformation of ammonia nitrogen in the wastewater, and leading to an improved removal efficiency.

The foregoing description is merely a preferred embodiment of the present disclosure and is not intended to limit the scope thereof. Any modifications, equivalent substitutions, improvements, or other variations made within the spirit and scope of the present disclosure shall be included within the scope of protection of the present disclosure.

What is claimed is:

1. A waste heat utilization-based bioelectrochemical ammonia recovery stack system, comprising a heat utilization unit, a cathode unit, an anode unit, a recovery unit, and a power supply;
wherein the heat utilization unit is provided with a wastewater inlet and a wastewater outlet; the cathode unit is provided with a catholyte inlet and a catholyte outlet, and a cathode is arranged in the cathode unit; the anode unit is provided with an anolyte inlet and an anolyte outlet, and an anode is arranged in the anode unit; the recovery unit is provided with an absorbent solution outlet; a negative terminal of the power supply is connected to the cathode, and a positive terminal of the power supply is connected to the anode;
wherein multiple cathode units are arranged on both sides of the heat utilization unit, and multiple anode units are arranged on an opposite side of each cathode unit, such that the multiple cathode units and multiple anode units are arranged on both sides of the heat utilization unit in an alternating sequence, with a cathode unit positioned at each outermost end, with the recovery unit arranged on a side opposite to the two last cathode units; wherein the heat utilization unit and the cathode unit, as well as the cathode unit and the anode unit, are each separated by a cation exchange membrane; and wherein the cathode units are further separated from the recovery units by plate-type composite ammonia separation membranes;
wherein multiple cathode units on a same side of the heat utilization unit are connected in series through the catholyte outlet of a preceding cathode unit and the catholyte inlet of a succeeding cathode unit; the anolyte inlets of multiple anode units on a same side of the heat utilization unit are connected in parallel to the wastewater outlet, or multiple anode units on the same side of the heat utilization unit are connected in series through the anolyte outlet of a preceding anode unit and the anolyte inlet of a succeeding anode unit, and wherein the anolyte inlet of the anode unit closest to the heat utilization unit is connected to the wastewater outlet.

2. The waste heat utilization-based bioelectrochemical ammonia recovery stack system according to claim 1, wherein the anode is a carbon-based material or a metal-based material; and the cathode is a carbon-based material or a metal-based material.

3. The waste heat utilization-based bioelectrochemical ammonia recovery stack system according to claim 2, wherein the anode is a carbon brush, carbon felt, or carbon cloth; and the cathode is a carbon brush, carbon felt, carbon cloth, stainless steel 316L, or stainless steel 304.

4. The waste heat utilization-based bioelectrochemical ammonia recovery stack system according to claim 1, configured such that the temperature of ammonia nitrogen wastewater charged into the heat utilization unit can be 40-100° C.; the catholyte charged into the cathode unit is NaCl solution; and the absorbent solution charged into the recovery unit is dilute sulfuric acid, dilute hydrochloric acid, or dilute nitric acid.

5. The waste heat utilization-based bioelectrochemical ammonia recovery stack system according to claim 4, wherein a concentration of the catholyte can be 40-60 mmol/L.

6. The waste heat utilization-based bioelectrochemical ammonia recovery stack system according to claim 1, wherein the plate-type composite ammonia separation membrane comprises a main membrane located in an intermediate layer and a supporting membrane arranged on both sides of the main membrane; a material of the main membrane is PTFE, a thickness of the main membrane is 0.32-0.36 mm, with a pore size of 0.1 μm; a material of the supporting membrane is PP.

7. The waste heat utilization-based bioelectrochemical ammonia recovery stack system according to claim 6, wherein the plate-type composite ammonia separation membrane further comprises supporting meshes arranged on both sides of the supporting membrane, and a material of the supporting mesh is a plastic network of heat-resistant materials.

8. An ammonia recovery method for the waste heat utilization-based bioelectrochemical ammonia recovery stack system according to claim 1, comprising the following steps:
S1, microbial activation:
S1.1, initiating by applying an external voltage to the anode unit and the cathode unit;
S1.2, introducing a mixture of the ammonia nitrogen wastewater and a microbial inoculum at room temperature into the anode unit, introducing a catholyte into the cathode unit, performing an influent flow continuously for acclimation, and maintaining a culture temperature at ambient temperature; and
S1.3, after the current is stable, achieving a successful activation; and
S2, ammonia nitrogen wastewater treatment:
introducing high-temperature ammonia nitrogen wastewater with a temperature of 40-100° C. into the heat utilization unit from the wastewater inlet; wherein, after the high-temperature ammonia nitrogen wastewater exchanges heat with an adjacent cathode unit, it flows into the anode units connected in parallel from the wastewater outlet, followed by discharging as treated wastewater from the anolyte outlet; alternatively, the high-temperature ammonia nitrogen wastewater sequentially passes through the anode units connected in series, which treat the high-temperature ammonia nitrogen wastewater in a gradient manner to gradually reduce the ammonia nitrogen concentration, and finally discharging treated wastewater from the anolyte outlet of a last anode unit; introducing the catholyte into the cathode unit through the catholyte inlet; generating electrons from organic matter at the anode, driving NH₄⁺ from the anode unit to enter the cathode unit through the cation exchange membrane by the resulting current, and converting the NH₄⁺ into free ammonia under alkaline conditions, achieving a concentration and enrichment of ammonia nitrogen through the catholyte containing free ammonia passes through multiple cathode units in series; after entering the last cathode unit, allowing the free ammonia to diffuse into the absorbent solution in the recovery unit through the plate-type composite ammonia separation membrane, and discharging a saturated absorbent solution from the absorbent solution outlet.

9. The ammonia recovery method according to claim 8, wherein
in S1.1, an external voltage of 0.8 V is applied;
in S1.2, a volume of ammonia nitrogen wastewater and microbial inoculum in the mixture is 1:1; a HRT of the mixture in the anode unit is 8-16 h;
in S2, a HRT of ammonia nitrogen wastewater in the anode unit is 5-16 h.
